(19) United States
(12) Patent Application Publication
(10) Pub. No.: US 2007/0184271 A1
(43) Pub. Date: Aug. 9, 2007

(54) Coated textile machinery parts

(76) Inventor: Michael D. Feldstein, Princeton, NJ (US)

Correspondence Address: Suface Technology, Inc., P.O. Box 8585, Trenton, NJ, 08650, US

(21) Appl. No.: 11/349,877

(22) Filed: Feb. 8, 2006

(51) Int. Cl. B32B 9/00

(52) U.S. Cl. 428/408

(57) ABSTRACT

Disclosed is a method for the coating of textile machinery parts with a composite coating bearing finely divided particles dispersed within a metallic matrix.

### BACKGROUND OF THE INVENTION

The plating of articles with a composite coating bearing finely dispersed divided particulate matter is well documented. This technology has been widely practiced in the field of electroplating as well as electroless plating. The acceptance of such composite coating stems from the recognition that the inclusion of finely divided particulate matter within metallic matrices can significantly alter the properties of the coating with respect to properties such as wear resistance, lubricity, friction, thermal transfer, and appearance.

Electroless composite technology is a more recent development as compared to electrolytic composite technology. The fundamentals of composite electroless plating are documented in a text entitled “Electroless Plating Fundamentals and Applications,” edited by G. Mallory and J. B. Hajdu, Chapter 11, published by American Electroplaters and Surface Finishers Society (1990).

The evolution of composite electroless plating dates back to Oderkerken U.S. Pat. No. 3,644,183 in which a structure of composite electroless plating with finely divided aluminum oxide was interposed between electrodeposited layers to improve the corrosion resistance. Thereafter, Metzger et al, U.S. Pat. Nos. 3,617,363 and 3,753,667 extended the Oderkerken work to a great variety of particles and miscellaneous electroless plating baths. Thereafter, Christini et al in Reissue U.S. Pat. No. 33,767 further extended the composite electroless plating to the codeposition of diamond particles. In addition, Christini et al demonstrated certain advantages associated with the deposition of the barrier layer (strike) prior to the composite layer.

Feldstein in U.S. Pat. Nos. 4,358,922 and 4,358,923 demonstrated the advantages of utilizing a metallic layer above the composite layer. The overlayer is essentially free of any particulate matter. Spencer in U.S. Pat. No. 4,547,407 demonstrated the utilizing of a mixture of dual sized particles in achieving improved smoothness of coating.

Feldstein et al in U.S. Pat. Nos. 4,997,686, 5,145,517, 5,300,330, 5,863,616, and 6,306,466 B1 demonstrated utilization of particulate matter stabilizers in the deposition of uniform stable composite electroless plating. Parker in U.S. Pat. No. 3,723,078 demonstrated the codeposition of refractory metals and chromium along with composite electroless plating.

Helle et al in U.S. Pat. Nos. 4,098,654 and 4,302,374 explored special surfactant compositions in the preparation of stabilized PTFE dispersions and their subsequent utilization in electrolytic plating.

Kurosaki et al in U.S. Pat. No. 3,787,294 proposed the use of cationic stabilizers for graphite fluoride be used in electroplating with specific attention focused upon surfactants having a C—F bond in their structure.

Brown et al in U.S. Pat. No. 3,677,907, demonstrated the utilization of surfactants also having a C—F bond in their skeleton used in combination with PTFE electrolytic codeposition.

Henry et al in U.S. Pat. No. 4,830,889, demonstrated the utilization of a cationic fluorocarbon surfactant along with a non-ionic fluorocarbon surfactant for the codeposition of graphite fluoride in electroless plating baths.

Feldstein et al in U.S. Pat. No. 5,580,375 also demonstrated the use of “frozen states” to overcome the limited shelf-life associated with certain dispersions before their use in plating applications.

Kanai in U.S. Pat. No. 4,677,817 demonstrated travelers with composite carbide coatings for use in ring spinning.

Nakano et al in U.S. Pat. No. 4,698,958 demonstrated rings with a ceramic coated layer for use in ring spinning.

Feldstein in U.S. Pat. No. 5,721,055 demonstrated benefits of composite coatings with lubricating particles on spinning textile machinery parts.

Feldstein in U.S. Pat. No. 6,309,583 demonstrated the ability to enhance the thermal transfer properties of articles coated with various composite coatings.

Feldstein et al in U.S. Pat. No. 6,506,509 demonstrated the ability to and utility of producing composite layers with varying densities of codeposited particles in the plated layer along the surface of the substrate.

The above patents reflect the state of the art and they are included herein by reference.

The following patents are provided for their schematic drawings for the machinery parts of interest in this invention.

Schmid in U.S. Pat. No. 5,164,236 describes the coating of open-end rollers with a metal-carbide coating with a nickel overlay thereof. The metal-carbide is deposited by a plasma coating approach.

Herbert et al in U.S. Pat. No. 4,193,253 describes the coating of OE rotors with a silicon carbide composite coating.

In addition, Kanai in U.S. Pat. No. 4,677,817 and Nakano et al in U.S. Pat. No. 4,698,958 illustrate well certain parts useful in ring spinning.

The coating of textile machinery parts has been a commercially accepted practice, especially when applied to open-end (OE) and ring spinning operations. For example, combing tolls (beater rolls) and rotors have been coated with composite bearing wear resistance particles such as diamond and silicon carbide. Rotor shafts used for open-end spinning have been coated primarily with a composite bearing silicon carbide. Similarly, rings and travelers used in ring spinning have been used with a variety of composite and other coatings. While it is well documented that the use of composite coatings bearing wear resistance particles extends the lifetime of machinery parts, their use creates certain potential problems as to the degradation of the physical properties of the yarn when contacted with the wear resistant coated machinery part. Accordingly, the present invention relates to textile spinning machine parts with an improved composite coating that is compatible with and provides improved results on the manufacture of certain textile materials. This criticality is becoming more pronounced as new man made fibers are developed and as the speed for the associated spinning parts is increased. The use of such coatings will provide a coated machinery part more friendly towards the yarn and the finish upon such yarns.

Composite electroless nickel coatings with diamond particles have been used significantly in the textile industry for roughly 25 years. One component used in this industry in the combing roll. Due to the abrasiveness of the contacting textile material, increased wear resistance is desired for these components. Combing rolls are used with many varieties of textile materials including natural and man-made fibers. The abrasiveness to the combing rolls varies depending on the variety of the fiber used and the grade of cleanliness of the fibers, as well as the type and speed of the combing roll, and other factors. One well established measure to combat the abrasive wear of the fibers to the combing rolls is to coat some or all portions of the combing rolls (at least the teeth portion) with a wear resistant coating. Electroless nickel composite coatings with diamond particles is the most widely used coating for this purpose. The most common specification for this coating is to apply a coating about 20-30 microns thick containing about 20-40% by volume of about 2.0 micron average size diamond particles into the coating. The coating may then be overcoated with a thinner layer of electroless nickel, and is then generally heat-treated to increase the hardness and adhesion of the coating. The overcoat generally replicates the surface profile of the underlying composite layer, but since the overcoat is somewhat softer than the composite layer, the surface will be able to smooth out easier and sooner than would be the case of the composite layer alone.

As is well know in the field of textile manufacturing and as can be seen on the surface of the traditional composite electroless nickel coatings used in this field, these traditional coatings, even those with an overcoat free of particles, may be too rough for effective use on combing rolls processing certain types of fibers. The problem with such roughness on the surface of textile machine parts is that this roughness can destroy small fibers not fully attached to the shaft of the yarn. This creates dust in the processing of the fibers that can accumulate in the groove of a rotor cup used in rotor spinning applications and other areas of the spinning aparatus. The accumulation of dust in this groove can lower yarn quality and cause yarn breaks.

These factors are especially relevant with polyester and various man-made fibers. An informative text on this matter was presented at the 44^{th} annual Technical Conference of the Society of Vacuum Coaters in April 2001 in Philadelphia, Pa. This text focuses on the processing of polyester fibers, and concurs that combing rolls used in open end spinning face substantial wear and require additional measures of wear resistant. Further, this text concurs that the traditional composite electroless nickel-diamond coating is too rough for the sensitive polyester fibers. The text, therefore, presents an alternative physical vapor deposition coating to add wear resistance without creating a part surface that is too rough for the sensitive polyester fibers. This text does not envision the possibility of replacing the large, about two micron, particles of the traditional composite coating with the smaller hard particles and subsequent finishing disclosed in the present invention. Similarly, suppliers of such combing rolls to the open end textile industry have developed other surface treatments designed to increase wear life of these critical parts while maintaining a surface profile compatible with various delicate textile materials. None of these methods, however, include the utility and novelty of the present invention. Moreover, these other methods suffer from various drawbacks, including high cost of manufacture and incompatibility with the substrate. Many coating or surface techniques that may be attractive in theory are not able to adhere to or replicate the complex geometry of parts that are the subject of this invention such as combing rolls, rings, travelers, rotors, and rotor shaft.

Aside from these more recent developments, users of these textile parts have used uncoated combing rolls or combing rolls coated with only a layer of conventional electroless nickel devoid of any particulate matter. The electroless nickel alone provides some added wear resistance and does not generate roughness on the surface. The added wear life provided by electroless nickel alone is less than commercially desirable for production and economic concerns.

More frequent replacement of worn components means additional cost for the replacement parts, and is a cost of time, labor, and lost productivity to accomplish the replacing of worn with new parts. Moreover, the quality of the textile product produced by the spinning parts will then not be consistent throughout the operating lifetime of the spinning parts. The initial quality produced by a new spinning part is often of lower quality until the part has been used for a sufficient period during which the part's surface is essentially polished. Once the part is sufficiently worn, the quality of the product again degrades. Therefore, the longer the main lifetime of the part can be prolonged will result in an extended period of producing a product of higher and more consistent quality. The coated parts associated with the present invention provide consistent production quality sooner, and an extended period of consistent and quality product.

As described above, it is the particles in the composite coatings used to date on such textile spinning parts that cause the roughness of the coating surface. This invention relates to producing combing rolls with a composite coating incorporating particles substantially smaller than the particles used commonly in the field. This invention also involves post-coating surface modification processes that have proven to make this type of coating and the benefits it provides, to textile spinning applications where such coatings were previously incompatible with certain types of textile materials.

### SUMMARY OF THE INVENTION

It is an object of the present invention to improve significantly the performance of open-end and ring spinning textile machinery parts and to eliminate many of the disadvantages associated with prior art coatings.

These and other objects of the present invention together with the advantages over the existing prior art and method will become apparent from the following specification and the method described herein.

### DETAILED DESCRIPTION

In describing the preferred embodiments of the present invention, specific terminology will be resorted to for the sake of clarity. However, the invention is not intended to be limited to the specific terms so selected, and is to be understood that each specific term includes all technical equivalence which operate in a similar manner to accomplish a similar purpose.

According to the concept of the present invention, the composite electroless coatings bearing particles of approximately one micron in size are applied onto open-end spinning machinery parts (rotors, combing rolls, navels, spinning rings, travelers, and others). The use of such coatings by contrast to composites bearing larger particles, will result in friendlier contact between the yarn and the coated machinery parts thereby minimizing any damage(s) to the yarns and resulting in improved physical properties for the processed yarn, and economy of use in such coated machinery parts. This invention further comprises the improvement of certain post coating smoothing operations which allow such coatings to be used reliably with certain textile materials.

The use of plasma coating was found in the prior art to be of special benefit in the case of certain fibers, e.g., rayon. However, the plasma coatings are limited in lifetime due to limited wear-life and moreover it is prone to chipping which is typical of vitreous type materials. By contrast, the present composites can provide with metallic matrices having a hardness value of up to around 1100 Hv.

Though the present invention primarily focuses upon diamond as the particulate matter to be used in the composite coatings for the specific textile machinery parts, other particles fall within the spirit of this invention. Other examples include, but are not limited to, silicon carbide, boron carbide, aluminum oxide, tungsten carbide and other hard particles fall within the spirit of this invention.

The present invention further incorporates the utility of including particulate matter with lubrication, release, or low friction properties within the coating containing wear resistant particulate matter for additional performance benefits.

As is common in the field of coating articles with wear resistant composite plated coatings, a post-plating heat treatment of at least 200 degrees Celsius is included within the scope of this invention. Electroless nickel phosphorous coatings are heat treated to a temperature of about 350 to 400 degrees Celsius for one or more hours to achieve maximum hardness of the metal matrix.

The present invention is intended to include any and all post-coating subsequent finishing operations that can achieve the polishing and/or surface modification necessary to produce a surface compatible with the uses of the articles described herein. Certain examples include, but are not limited to, polishing, sanding, grinding, honing, abrasive blasting, blasting with spherical or generally spherical materials, tumbling, electro polishing, and deburring. Such finishing operations are not simply an accelerated substitute for actual use of the part as will be seen in the following example.

### EXAMPLE 1

The following example is an illustration whereby diamond particles with a mean particle size of one micron are codeposited in a hard metallic matrix. It should be noted that the present invention is not limited to the type of bath used herein, but in general for electroless deposits of the various metals and alloys. Moreover, the invention is not limited to the specific particles used.

In the current example an electroless nickel plating bath, NiPlate 830 sold by Surface Technology, Inc., was used to provide a Ni—P type alloy. The bath was operated at a pH of 6.3 and a temperature of 168 degrees F., and a cycle time of 65 minutes. Into a plating tank of 19 liters consisting of the NiPlate 830 bath, an aqueous dispersion of diamond particles with a mean particle size of about one micron was added along with DI water to produce a final volume of 19 liters. Open end spinning combing rolls, after normal cleaning and pickling were plated for 65 minutes under the above conditions. The coated combing rolls were then heat treated at a temperature above 200 degrees C. A cross sectional cut revealed a significant quantity of codeposited diamond particles.

Some of the combing rolls as prepared above were then tested in an open end textile spinning apparatus with a synthetic textile material. The wear resistance of the coating appeared to be useful for the application. Whereas this coating produced less dust within the apparatus compared to a similar combing roll coated with a conventional composite coating with 2 micron sized diamond particles, the dust generated by the above combing rolls was still more than would be desirable for practical use. Moreover, the portions of the coated combing rolls' surface began to develop some accumulations of a material (often called avivage or softener) from the textile material, though not as much as would accumulate on a combing roll with a coating bearing the traditional larger particles such as 2 micron.

Other combing rolls as prepared above were then polished by two different methods to smooth the surface before testing in the same apparatus and textile material as above. Combing rolls polished by each method noted above, however, generated a substantially decreased amount of dust in the test apparatus. The resulting level of dust was certainly within a practical use range.

An unanticipated and additional advantage of this treatment of combing rolls was that there was no accumulation of the material (often called avivage or softener) from the textile material onto the combing roller. Accumulation of such material is common with combing rolls treated by means other than that described in the present invention. Such material is problematic to continued operation of the combing rolls and such material is very difficult to practically impossible to remove. Therefore the coating as disclosed in the present invention provides a benefit that is not simply an accelerated substitute for actual use on the part since there is no accumulation of this material onto the part as would occur with a conventionally treated part.

While this example demonstrates the advantage of the present invention for open end combing rolls, the present invention will also produce advantageous results for other open end spinning parts such as rotor cups that are also in contact with textile fibers that would produce dust in use, and other parts in other types of textile manufacturing where wear resistance and controlled surface characteristics are necessary. Ring spinning applications are one such example. Other such applications even include ones that utilize similar teeth as combing rolls such as carding flats and other applications. This invention is further envisioned to make such coatings feasible and provide similar performance advantages in non-textile applications that have other materials that are also sensitive to the surface of the coated objects.

It should be reiterated that repeated tests of parts coated with conventional composite coatings bearing approximately 2 micron or higher average sized particles have proven to be incompatible with certain textile materials, especially synthetic fibers. Moreover, experiments have been made to modify such conventional coatings via overcoating and/or post coating polishing, but have failed to make such coatings compatible with the materials desired.

It was surprisingly found that a composite coating as produced in the above example provides a surface topography closely resembling conventional electroless nickel devoid of particles with a surface useful for these machinery parts, despite the fact that the coating under the present invention contains a significant percent of particulate matter.

1. An article having a coating formed thereon, said coating consisting essentially of finely divided wear resistant particulate matter with an average particle size of about one micron dispersed within a metal matrix, and wherein said coating is modified by one or more subsequent finishing operations.

2. The article according to claim 1, wherein said average particle size is less than 1.0 micron.

3. The article according to claim 1, wherein said wear resistant particulate matter contains diamond.

4. The article according to claim 1, wherein said article is useful in textile processing.

5. The article according to claim 1, wherein said article is a combing roll useful in open-end spinning processing.

6. The article according to claim 1, wherein said article is a rotor cup useful in open-end spinning processing.

7. The article according to claim 1, wherein said article is useful in ring spinning operations.

8. The article according to claim 1, wherein said article is a ring useful in ring spinning operations.

9. The article according to claim 1, wherein said article is a traveler useful in ring spinning operations.

10. The article according to claim 1, wherein said metal matrix is an alloy containing nickel.

11. The article according to claim 1, wherein said wear resistant particulate matter is selected from the group consisting of silicon carbide, boron carbide, aluminum oxide, tungsten carbide, and mixtures thereof.

12. The article according to claim 1, wherein said wear resistant particulate matter is selected from the group consisting of diamond, silicon carbide, boron carbide, aluminum oxide, tungsten carbide, and mixtures thereof in addition to particulate matter with lubrication, release, or low frictional properties.

13. The article according to claim 1, wherein said metal matrix contains materials selected from the group consisting of nickel, phosphorous, boron, cobalt, and mixtures thereof.

14. The article according to claim 1, wherein said metal matrix is deposited by an electroless method of deposition.

15. The article according to claim 1, wherein said coating has a portion thereof for contacting a textile yarn during use of said article.

16. The article according to claim 1, wherein said article is heat treated to a temperature of at lease 200 degrees Celsius.
